(19) United States
(12) Patent Application Publication
(10) Pub. No.: US 2026/0257422 A1
(43) Pub. Date: Sep. 3, 2026

(54) EQUIPMENT AND PROCESS FOR THREE-DIMENSIONAL PRINTING COMPOSITE MATERIALS

(71) Applicant: MOI COMPOSITES S.R.L, Milano (IT)

(72) Inventors: Giuseppe GARABELLI, Ciserano (IT); Gabriele Ottavio DE IACO, Alliste (IT); Gabriele NATALE, Supersano (IT); Tommaso GERI, Montescudaio (IT); Michele TONIZZO, Codroipo (IT)

(21) Appl. No.: 19/163,862

(22) PCT Filed: Apr. 12, 2024
(86) PCT No.: PCT/IB2024/053583

§ 371 Date: Sep. 10, 2025

(30) Foreign Application Priority Data
Apr. 24, 2023 (IT) 102023000008034

(51) Int. Cl. B29C 64/321; B29C 48/02; B29C 48/30; B29C 64/118; B29C 64/209; B33Y 10/00; B33Y 30/00; B33Y 40/00

(52) U.S. Cl. CPC B29C 64/321; B29C 48/02; B29C 48/302; B29C 64/118; B29C 64/209; B33Y 10/00; B33Y 30/00; B33Y 40/00

(57) ABSTRACT

Equipment and a process for three-dimensional printing of composite materials are described, said equipment comprising:—a feeding head for feeding at least one continuous filiform element; said continuous filiform element comprising at least one dispersed phase and at least one continuous phase; said feeding head comprising at least one deposition apparatus arranged in its end portion;—a movement assembly for the relative movement between the feeding head (50) and the three-dimensional object (20) to be printed and/or supporting surface (9);—at least one energy source (8) configured to deliver a pre-set amount of energy to said continuous filiform element (4); said deposition apparatus (50) comprises:—a device (40) for varying the shape of the section of the continuous filiform element (4) being deposited, comprising at least one side surface configured to be in contact with the continuous filiform element (4), thus occupying at least one portion of the outer perimeter of the section of said continuous filiform element (4) and so as to define an empty portion on the outer perimeter of the section of said continuous filiform element (4) equal to or greater than 5% of the outer perimeter of the section of said continuous filiform element (4).

### FIELD OF THE INVENTION

The present invention concerns the field of three-dimensional printing of composite materials.

In particular, the present invention concerns equipment and a method for three-dimensional printing of fiber composite materials and thermoplastic or thermosetting matrix.

### KNOWN ART

As known, the term “composite” generally means a material obtained by combining two or more components so as the final product has different properties from those of the individual constituents. In order to better identify what is meant by the term “composite” in the technical field, it is customary to limit the class of composite materials to reinforced materials only, in which at least one component, usually in the form of fibers, has much greater mechanical characteristics than the others.

Generally, the join, by adhesion or cohesion, of two or more components different in shape and chemical composition, which are insoluble in each other and separated by an interface, can be defined as “composite material” or simply “composite”.

Composite materials generally are constituted by a continuous phase (named matrix) and a dispersed phase (often in the form of a reinforcing element). Mechanical properties of the material (strength and rigidity) are mainly entrusted to the dispersed phase, whereas the task of transferring the external loads applied to the dispersed phase is entrusted to the continuous phase. This transmission occurs as a result of shear stresses acting at the interface between dispersed phase and continuous phase. Moreover, in addition to stabilizing the composite by compression, the matrix has the task of holding together and protecting the fibers and of shaping the piece.

Ultimately, a composite material is a multiphase material which can be created artificially and which is different from the constituents: depending on the principle of the combined actions, the optimization of a property is obtained by means of the careful and designed combination of two or more different materials.

Depending on the material of the matrix constituting the continuous phase, the composites are classified as a metal matrix, a ceramic matrix and a polymer matrix.

The polymer matrix composites are generally constituted by reinforcing fibers (for example carbon, nylon, aramid or glass) embedded into a polymer matrix which surrounds, protects and binds the fibers. Typically, fibers constitute about 50/60% by volume of a polymer matrix composite.

In turn, there are two subclasses of materials composing the polymer matrix within the polymer matrix category, these are: thermoplastic polymers and thermosetting polymers.

The thermoplastic polymers are a group of plastic materials which gain malleability under the action of temperature. Subjected to the action of temperature, the thermoplastic polymers can be molded or shaped into finished objects and can, thus, return to being rigid structures once cooled. In fact, the viscosity decreases with the increasing of temperature but also with the increasing of the shear rate and shear stress. This heating/cooling cycle can theoretically be repeated several times depending on the qualities of the different plastic materials; in practice, it is possible to repeat the cycle for a limited number of times since too many heating cycles can degrade the polymers.

The thermosetting polymeric materials have a cross-linked molecular structure formed by covalent bonds. The thermosetting polymers are cross-linked by means of a process named “curing,” through which the resin undergoes a series of chemical transformations in the fluid state, passing through a gelled or rubbery state until passing to the vitreous state. Some thermosetting resins are cross-linked by means of heat or through heat and pressure combined. In other cases, the chemical reaction can occur at room temperature (cold thermosets) by means of light radiation, evaporation of substances, activation by means of moisture and, finally, due to the forced mixing of two elements (generally resin and catalyst).

Although thermosetting resin manufactured articles can soften as a result of the heat (Tg, glass transition temperature), the covalent bonds in the lattice prevent them from returning to the fluid state that existed before cross-linking; even better, if heating results in exceeding the degradation temperature they rather decompose by carbonizing. Thermosetting materials cannot thus be reheated and thus melted as occurs with thermoplastics.

Processes for three-dimensional printing of composite materials are for example described in U.S. Pat. Nos. 9,987,798, 10,011,073 and 9,126,367.

The applicant observed that the processes for three-dimensional printing of composite materials with a continuous fiber reinforcement that are implemented with the aid of numerically controlled deposition systems or robots provided with 3 or more degrees of freedom can have functional and/or aesthetic defects in the layer deposited. In fact, in section, each layer appears to be constituted by the joining of several strands of filiform elements placed side-by-side, thus distinguished by a series of empty portions (devoid of material) arranged between one strand and the adjacent one. This defect is caused by the morphology of the strand and by the difficulty of making a strand of section so as to minimize the defects and maximize the useful contact surface. These surface defects limit the applicability horizon of composite components obtained through additive manufacturing.

In order to try to overcome such limitation, the use of shaping equipment based on rollers capable of imparting pressure on the filiform element being deposited was suggested. Although this type of solution is an improvement with regard to the adhesion between the layers and contributes to reducing the overall degree of voids within the manufactured article, it is also clear that said pressure applied on the filiform element anyhow determines a ribbon-like morphology (i.e. low layer height/layer width ratios). This type of solution is adapted for producing objects characterized by two characteristic dimensions prevailing over the third, the height. Whenever such solution should be used for making three-dimensional objects, thus objects not characterized by two dimensions prevailing over the third, in the production of heavier products this would result in objects distinguished by a high wall thickness and with a significant increase in production times.

The Applicant also observed that with this solution the degree of quality of the manufactured article depends on the pressure applied. In other words, the system described above, which provides shaping equipment based on rollers, does not allow to arbitrarily change the height/width ratio of the layers of material to be deposited without incurring inhomogeneity in the manufactured article produced and also undesired variations in the expected adhesion value between the layers.

Consequently, said shaping systems are not adapted for making geometries characterized by curvatures in the growth direction of the manufactured article and are inadequate for the deposition of continuous filiform elements according to intersecting trajectories on the same plane or surface.

The Applicant has thus addressed the problem of providing equipment and a method for three-dimensional printing of continuous fiber composite materials which solves the drawbacks of the known art, in particular in terms of limitations resulting from the known shaping systems and processes.

### SUMMARY OF THE INVENTION

Thus, in a first aspect, the invention refers to equipment for three-dimensional printing of continuous fiber composite materials, comprising:
a feeding head for feeding at least one continuous filiform element; said continuous filiform element comprising at least one dispersed phase and at least one continuous phase; said feeding head comprising at least one deposition apparatus arranged in its end portion;
a movement assembly for the relative movement between the feeding head and the three-dimensional object to be printed and/or a supporting surface;
one energy source configured to deliver a pre-set amount of energy to said continuous filiform element;
characterized in that said deposition apparatus comprises:
a device for varying the shape of the section of the continuous filiform element, comprising at least one side surface configured to be in contact with the filiform element, thus occupying at least one portion of the outer perimeter of the section of said filiform element and so as to define an empty portion on the outer perimeter of the section of said continuous filiform element equal to or greater than 5% of the outer perimeter of the section of said continuous filiform element.

The Applicant observed that the use of a device for varying the shape of the section of the filiform element in which at least part of the perimeter of the shaping profile is lacking, since replaced by the contact interface between the filiform element being deposited and the three-dimensional object or supporting surface or both, allows to overcome the limitations of the known art.

Said device for varying the shape of the section of the filiform element allows to impart a pre-set shape to the section of the filiform element being deposited, which is adapted for reducing the number of voids in said filiform element and between side-by-side and/or overlapping filiform elements.

Conveniently, said device for varying the shape of the section of the filiform element can be configured to impart a polygonal shape to the section of the filiform element being deposited. Alternatively, part of the shaping profile can be configured so as to impart a curvilinear shape to at least one part of the section of the filiform element being deposited.

For the purposes of the present invention, the following definitions apply.

“Section of filiform element” means the plane curve resulting from the intersection of the filiform element being deposited with the plane having the axis tangential to the deposition path as its normal. Said section is characterized by its own shape, area and perimeter.

“Longitudinal direction” is generically meant as a direction parallel to the sliding direction of the continuous filiform element inside the deposition apparatus.

“Translation” of a wall means a substantially rigid movement of the same wall which occurs so as each straight line passing through any couple of its points keeps substantially unchanged direction.

In the aforesaid aspect, the present invention can have at least one of the preferred characteristics described hereunder.

Conveniently, said device for varying the shape of the section of the filiform element comprises at least two movable walls configured so as at least one of said movable walls is in contact with the filiform element being deposited, thus occupying at least one portion of the outer perimeter of the section of said continuous filiform element; said movable walls being movable away from or towards the center of the section of the filiform element.

Preferably, the at least two movable walls occupy at least 30% of the outer perimeter of said filiform element.

Conveniently, the at least two movable walls comprise two side walls opposite with respect to the continuous filiform element; each side wall comprising a free end and an end constrained to a head.

Advantageously, the equipment comprises a movement assembly for moving said side walls and which comprises at least one actuator configured to determine the translation of the side walls according to an inclination angle with respect to the extension direction of the continuous filiform element.

Preferably, the aforesaid at least one actuator comprises an electric motor which drives, by means of a return pulley, a return cable combined, by means of an elastic element, with a side wall.

Advantageously, an upper wall is arranged inside the deposition apparatus so as to be positioned orthogonally to said side walls.

Conveniently, there is further present a movement assembly for moving the upper wall and which comprises at least one actuator which determines the translation of the upper wall with respect to the extension direction of the continuous filiform element inside the deposition apparatus.

Conveniently, the deposition apparatus comprises a device adapted for measuring the pressure exerted by the upper wall onto the continuous filiform element. The operation of the movement assembly and/or the movable walls can be corrected by measuring said pressure, depending on the value detected with respect to the expected value.

According to a further aspect, the present invention concerns a process for three-dimensional printing of continuous fiber composite materials with the equipment referred to above and comprising the steps of:
feeding at least one continuous filiform element to a deposition apparatus; said filiform element comprising at least one dispersed phase and at least one continuous phase able to undergo chemical and/or physical changes as a result of a delivery of energy. The continuous filiform element can be wound on specific bobbins or can come from an impregnation device, not described since of a known type, placed upstream of the outlet mouth and so as at least one movement axis is interposed between said outlet mouth and said impregnation device;
setting the aforesaid device to vary the shape of the section of the continuous filiform element,
depositing the continuous filiform element onto a supporting surface or three-dimensional object;
delivering a pre-set amount of energy to said filiform element so as to induce a chemical and/or physical change in said filiform element and, as a result of said change, to produce one anchorage point between said filiform element being deposited and said supporting surface or three-dimensional object. Said continuous phase constituting said filiform element is selected for being able to quickly make said anchorage point as a result of said chemical and/or physical change, thus determining the possibility to create the three-dimensional object.
displacing said feeding head with respect to the anchorage point according to a pre-set path defining the object to be printed and simultaneously exerting a tractive force onto said continuous filiform element. Said tractive force drives the coming out of said filiform element from the outlet mouth of the deposition apparatus and is generated as a result of the relative movement between the feeding head and said anchorage point on the supporting surface and/or three-dimensional object;
during the depositing step, inducing said chemical and/or physical change in a new portion of the filiform element deposited by said feeding head and, as a result of said change, determining, instant by instant, a new anchorage point between said filiform element being deposited and said supporting surface and/or three-dimensional object.
cutting the continuous filiform element, preferably inside the feeding head.

The setting step is preferably implemented during the depositing step.

Advantageously, said setting step is implemented upstream of said depositing step.

Further characteristics and advantages of the invention will become clearer in the detailed description of some preferred, but not exclusive, embodiments of an apparatus and a method for three-dimensional printing of fiber composite materials according to the present invention.

### BRIEF DESCRIPTION OF THE DRAWINGS

Such description will be set forth hereunder with reference to the accompanying drawings provided by way of example only and thus not limiting, in which:

FIG. 1 shows equipment for three-dimensional printing of composite materials, comprising a movement assembly and a feeding head, a supporting surface and a three-dimensional object and which implements the method according to the present invention;

FIG. 2 shows the feeding head of the equipment for three-dimensional printing of composite materials of FIG. 1;

FIGS. 3a-3b show two bottom views, respectively in solid lines and in transparency, of an end portion of the feeding head according to the present invention;

FIGS. 4a to 8b show successive times of the cutting step for cutting a continuous filiform element inside the end length of the feeding head;

FIG. 9 shows an inner perspective view of the deposition apparatus according to the present invention;

FIG. 10 shows an inner and exploded perspective view of the deposition apparatus of FIG. 9, in which some components in charge of cutting the continuous filiform element were omitted for representation clarity.

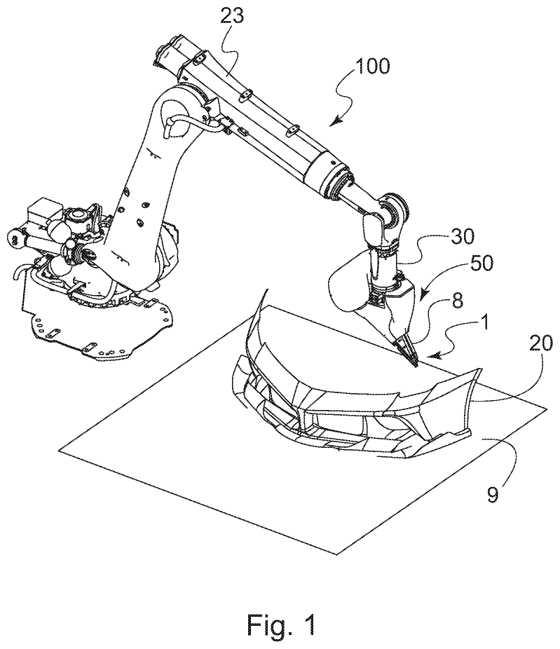

### DETAILED DESCRIPTION OF EMBODIMENTS OF THE INVENTION

With reference to the figures, equipment for three-dimensional printing of fiber composite materials is denoted in its entirety by the numerical reference 100. In particular, the equipment 100 is adapted for printing a composite material starting from a continuous filiform element 4 constituted by at least one continuous phase and at least one dispersed phase.

The equipment 100 comprises a feeding head 50 of a continuous filiform element 4, a supporting surface 9 onto which the continuous filiform element 4 is deposited to make the preferably three-dimensional object 20 to be printed, a movement assembly for the relative movement between the feeding head 50 and the supporting surface 9, so as to exert traction of the continuous filiform element 4, at least one energy source 8 configured to deliver a pre-set amount of energy to the continuous filiform element 4. Said energy delivered to the continuous filiform element 4 determines a chemical and/or physical change thereof as a result of which an anchorage point is made between said continuous filiform element being deposited and said supporting surface 9 and/or three-dimensional object 20. The relative movement between the feeding head and said supporting surface 9 and/or three-dimensional object 20 determines a tractive force on the filiform element itself that determines its coming out from the outlet mouth 10 of said deposition apparatus 1.

In the embodiment shown in the figures, the feeding head has a deposition apparatus 1 which is like a tubular element tapered in direction of the outlet mouth 10 of the continuous filiform element 4.

The feeding head 50 can further internally comprise a cutting device 2 comprising at least one cutting edge 3.

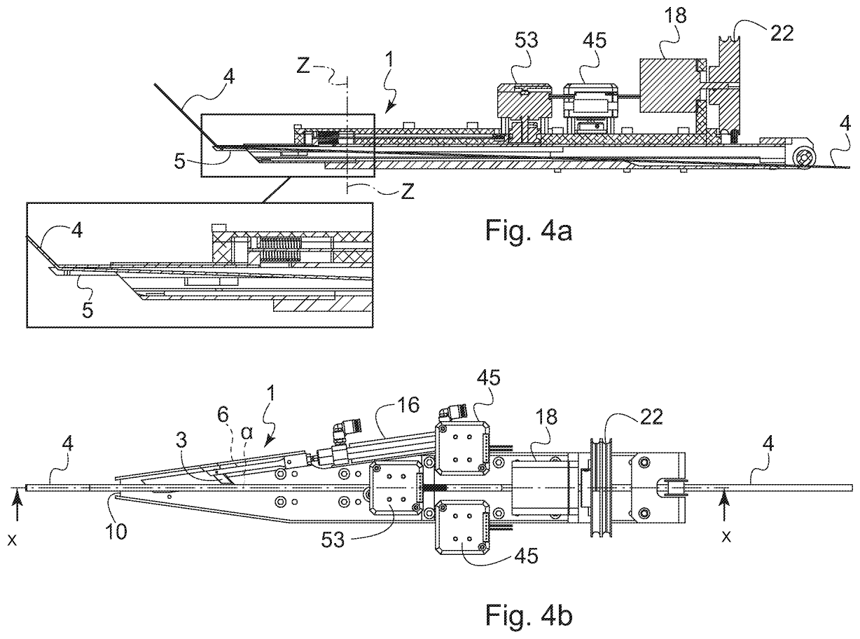

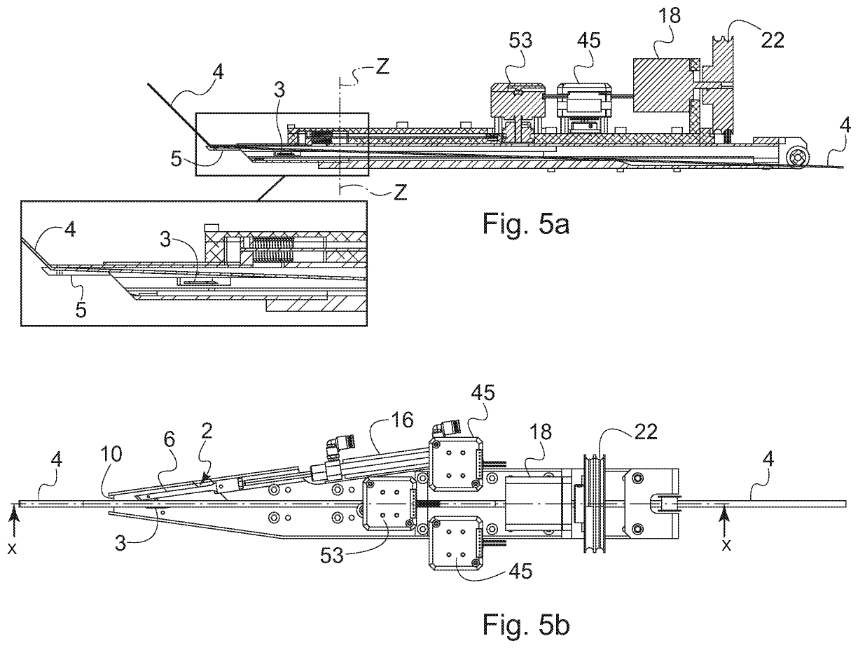

In the embodiment shown in the figures, the cutting device 2 comprises a supporting arm 6 for supporting said cutting edge 3 and which is movable between a backward position (FIGS. 4A-4b), in which it is away from the extension direction X-X of the continuous filiform element 4 in plan view, and a cutting position (FIGS. 5A-5b), in which the cutting edge 3 intersects the extension direction X-X of the continuous filiform element 4.

The supporting arm 6 extends substantially accordingly to the extension direction X-X of the continuous filiform element 4. In other words, in plan view, the supporting arm 6 is arranged substantially parallel or slightly inclined (less than 45°) with respect to the extension direction X-X.

The supporting arm 6 has the aforesaid cutting edge 3 at one of its ends.

In a further embodiment not shown in the figures, the cutting device 2 further comprises, in addition to the supporting arm 6 and the cutting edge 3, an elastic element which allows the relative movement between the supporting arm 6 and the cutting edge 3. Preferably, the relative movement is of the rotary type and allows the cutting edge 3 to be pulled back, thus allowing the step of moving forward towards the cutting position of the supporting arm 6 also whenever the extension direction of the supporting arm 6 intersects the extension direction X-X of the continuous filiform element 4. Preferably, the elastic element is an element made of harmonic steel, arranged on the side of the supporting arm 6. Advantageously, the cutting edge 3 comprises a portion with a cam profile which allows, through contact with the elastic element, to reposition the cutting edge 3 after interaction step with the continuous filiform element 4. Moreover, the cutting edge 3 advantageously comprises a countering portion for countering the supporting arm 6, so as to allow a force of reaction during the cutting step of the continuous filiform element 4 as the supporting arm 6 is pulled back. According to this embodiment, the cutting device 2 cannot be moved away sideways from the extension direction X-X of the continuous filiform element and, since it is not necessary to avoid intersections between the extension direction of the supporting arm 6 and the extension direction X-X of the continuous filiform element 4, it is possible to vary the total length of the deposition apparatus 1 whenever advantageous, thus favoring the compactness of the feeding head 50 and/or the freedom of movement of the feeding head 50.

At the remaining end, the supporting arm 6 is functionally combined with a movement assembly 3 comprising an actuator 16 for moving the supporting arm and, consequently, the cutting edge itself.

In the embodiment shown in the figure, the actuator 16 is of the pneumatic type and comprises a piston cylinder 17 connected to the supporting arm 6 of the cutting edge 3, so that the movement of the piston cylinder 17 translates the supporting arm 6, and consequently the cutting edge 3, forward or backward.

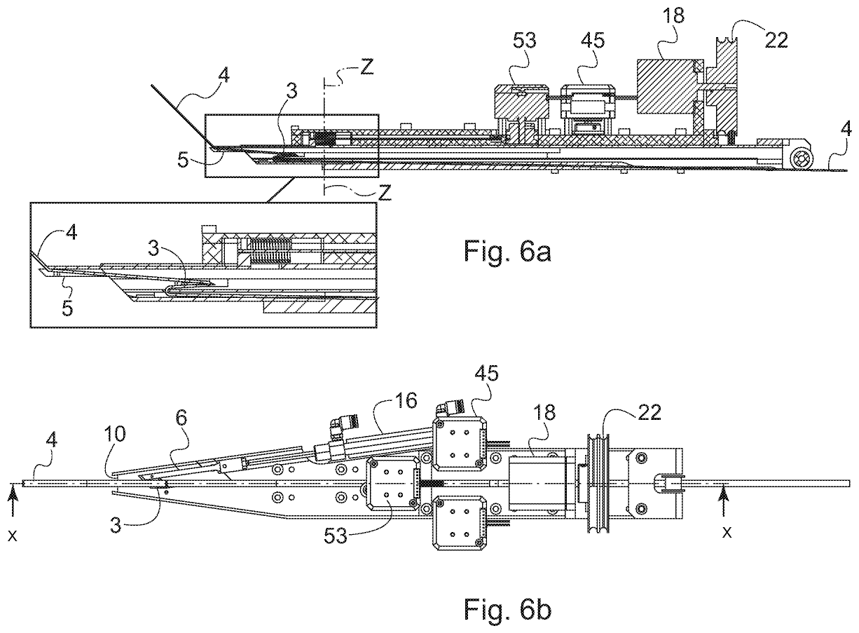

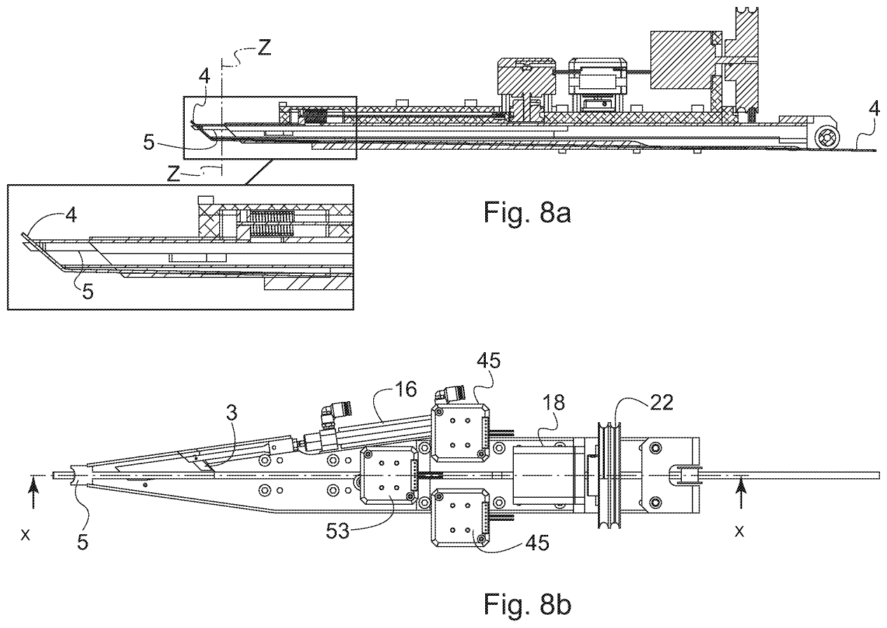

The deposition apparatus 1 further comprises a conveyor 5 movable between a backward position (FIGS. 4a-4b), in which it is away from the cutting edge 3, an intermediate position (FIGS. 6a-6b), in which it is arranged at least partially below said cutting edge and places the filiform element 4 in interference with the cutting edge 3 whenever the cutting edge 3 is in its cutting position, and a forward position (FIGS. 8a-8b).

In the embodiment shown in the figures, the conveyor 5 is like a thin bar translatable along the extension direction X-X of the continuous filiform element 4.

The conveyor 5 has, in plan view, a width L equal to or greater than the width, in plan view, of the filiform element 4 whenever the latter is considered upstream of the shaping system.

At its leading end 11, the conveyor 5 has an engagement portion 12 for engaging the continuous filiform element 4.

At the remaining end, the conveyor 5 is functionally combined with a movement assembly of the conveyor itself which comprises at least one actuator 18 which determines the translation of the conveyor 5 from its backward position to the intermediate position and to its forward position and vice-versa.

In the embodiment shown in the figures, the actuator 18 comprises an electric motor 19 which drives, by means of return pulleys 22, a conveying cable 21 combined to the conveyor 5.

The operation of the shaft of the electric motor 19 in one direction brings the conveyor 5 forward, whereas the rotation of the shaft of the electric motor 19 in the opposite direction brings the conveyor 5 backward.

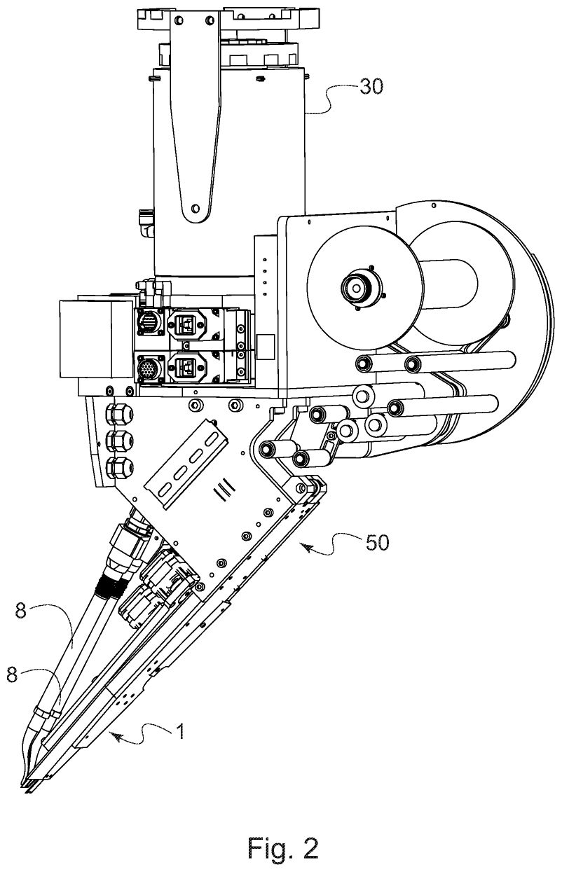

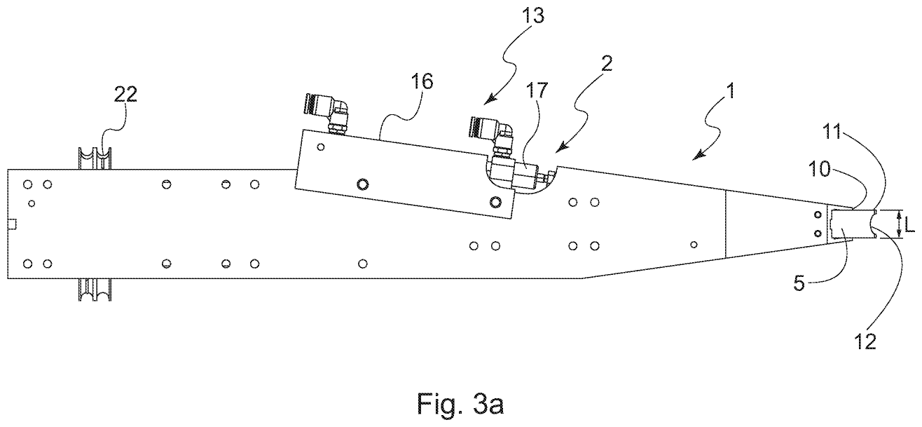

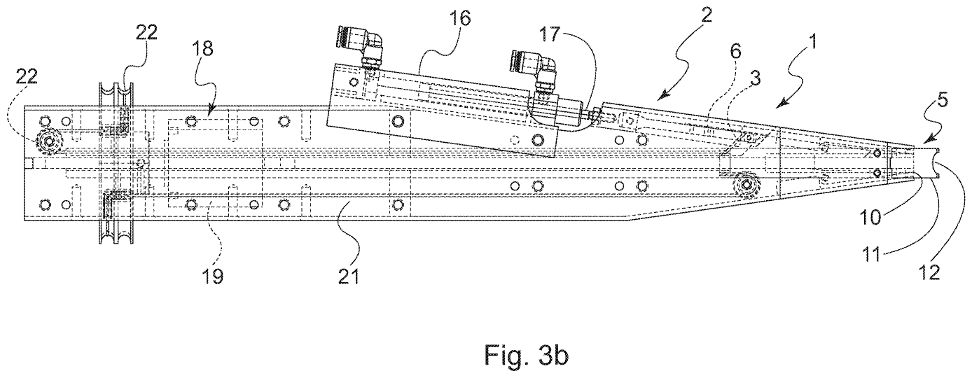

The feeding head 50 can be mounted on a rotating joint 30 which allows infinite rotation of the feeding head 50 with respect to an end axis, as for example shown in FIG. 2.

The feeding head 50 further comprises a device 40 for varying the shape of the section of the filiform element, configured to impart a pre-set shape to the section of the filiform element being deposited.

In other words, the device 40 for varying the shape of the section of the filiform element is adapted for reducing the number of voids between side-by-side and/or overlapping filiform elements.

The device 40 for varying the shape of the section of the continuous filiform element comprises at least one surface configured to be in contact with the continuous filiform element 4 being deposited, thus occupying at least one portion of the outer perimeter of the continuous filiform element 4, so as to define an empty portion on the outer perimeter of the shaping element equal to or greater than 5% of the outer perimeter of the filiform element 4 being deposited.

Thanks to the device 40 for varying the shape of the section of the continuous filiform element, the shape of the section of the continuous filiform element 4 is imparted by the action of combined containment of the at least one wall of the device 40 and of the continuous filiform element previously deposited and/or supporting surface.

For such purpose, the device 40 for varying the shape of the section of the continuous filiform element 4 advantageously comprises movable walls 41, 42, 43 arranged around the continuous filiform element 4. The latter slides between the movable walls 41, 42, 43 while being deposited onto the supporting surface 9 and/or onto the three-dimensional object 20.

The movable walls 41, 42, 43 are movable at least partially towards or away from each other, to change the shape ratio of the section of the continuous filiform element 4.

In an embodiment shown for example in FIGS. 8, 9, 10, there are at least two movable walls 41, 42, 43 configured to be in contact with the continuous filiform element 4 being deposited, thus occupying at least one portion of the perimeter of the section of said continuous filiform element 4.

In detail, there are two side walls 41, 42 and one upper wall 43.

The side walls 41, 42 and the upper wall 43 are configured and arranged to cover at least 30% of the perimeter of the continuous filiform element 4 in plan view.

The movable walls 41, 42, 43 are movable away from or towards each other by specific actuators movable synchronously or asynchronously and operable independently.

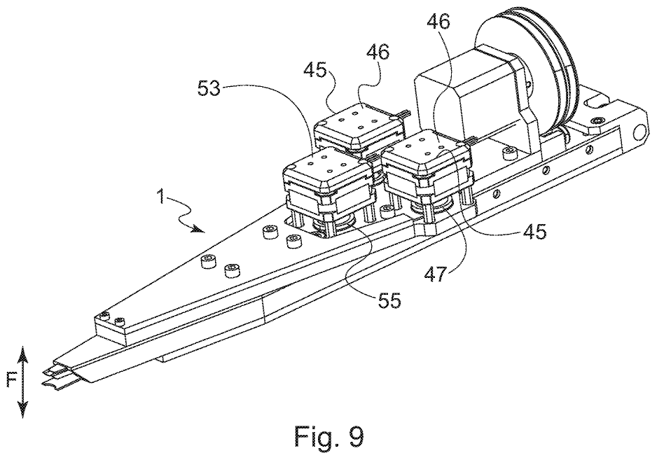

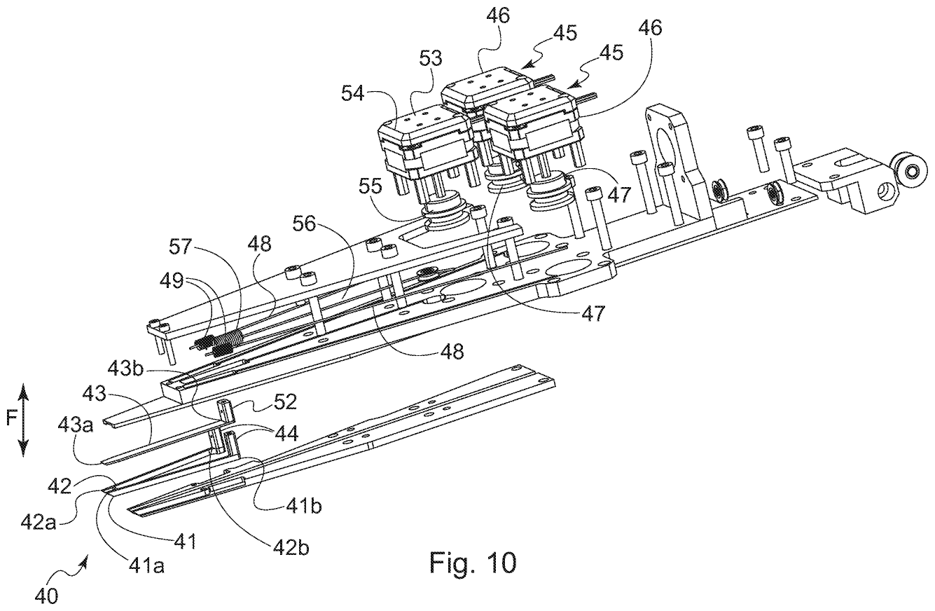

In the embodiment shown in FIGS. 9-10, the side walls 41, 42 are like two elongated blades arranged inside the deposition apparatus 1, so as to be opposed to the continuous filiform element 4 when the latter is being deposited.

The two side walls 41, 42 are configured to be in contact with the continuous filiform element 4 at least for one of their portions.

In particular, each side wall 41, 42 comprises a free end 41a, 42a and an end 41b, 42b constrained to a head 44.

Preferably, the two side walls 41, 42 are configured to be in contact with the continuous filiform element 4 at least for 60% of the longitudinal extension of their said free end.

Even more preferably, the two side walls 41, 42 are configured to be in contact with the continuous filiform element 4 at least for 70% of the longitudinal extension of their said free end.

At their constrained end 41b, 42b, each side wall 41, 42 is functionally combined with a movement assembly of the side wall itself which comprises at least one actuator 45 which determines the translation of the side walls 41, 42, according to an inclination angle with respect to the longitudinal extension direction of the continuous filiform element 4.

The translation of the side walls 41,42 brings at least the free ends 41a, 42a of the side walls towards or away from each other, thus compressing the continuous filiform element 4 or allowing it to expand sideways while or just before being deposited.

In the embodiment shown in the figures, each actuator 45 comprises an electric motor 46 which drives, by means of a return pulley 47, a return cable 48 combined with a side wall 41, 42 by means of an elastic element 49.

The operation of the shaft of the electric motor 46 in one direction exerts traction on the return cable 48 and a consequent compression on the elastic element 49, so that the side walls 41, 42 translate towards the electric motor 46, thus bringing their free ends 41a, 42a away from each other. Vice-versa, the operation of the shaft of the electric motor 46 in the opposite direction exerts a release of the return cable 48 and the elastic recovery of the elastic element 49, no longer countered by the tension of the return cable 48, makes the side walls 41, 42 translate away from the electric motor 46, thus bringing the free ends 41a, 42a towards each other and compressing the continuous filiform element 4 sideways.

The upper wall 43 is also like an elongated blade arranged inside the deposition apparatus 1 so that to be positioned orthogonally to the two side walls 41, 42 and, with reference to the figures, above the continuous filiform element 4 whenever the latter is being deposited.

The upper wall 43 is configured to be in contact with the continuous filiform element 4 at least for a portion thereof.

In particular, each upper wall 43 comprises a free end 43a and an end 43b constrained to a head 52.

Preferably, the upper wall 43 is configured to be in contact with the continuous filiform element 4 at least for 60% of the longitudinal extension of its said free end.

Even more preferably, the upper wall 43 is configured to be in contact with the continuous filiform element 4 at least for 70% of the longitudinal extension of its said free end.

At its constrained end 43b, the upper wall 43 is functionally combined with a movement assembly of the upper wall itself which comprises at least one actuator 53 which determines the translation of the upper wall 43 with respect to the extension direction of the continuous filiform element 4.

The translation of the upper wall 43 compresses or allows the section of the continuous filiform element to be expanded according to a direction orthogonal to the side walls 41, 42 while or just before being deposited.

In the embodiment shown in the figures, the actuator 53 comprises an electric motor 54 which drives, by means of a return pulley 55, a return cable 56 combined with the upper wall 43 by means of an elastic element 57.

The operation of the shaft of the electric motor 54 in one direction exerts traction on the return cable 56 and a consequent compression on the elastic element 57, so that the upper wall 43 translates towards the electric motor 54, thus allowing the vertical expansion, i.e. denoted by the arrow F in the figure, of the shape of the section of the continuous filiform element 4. Vice-versa, the operation of the shaft of the electric motor 54 in the opposite direction exerts a release of the return cable 56 and the elastic recovery of the elastic element 57, no longer countered by the tension of the return cable 56, makes the upper wall 43 translate away from the electric motor 54, thus compressing the section of the continuous filiform element 4 vertically.

The feeding head 50 is advantageously supported by the movement assembly for the relative movement between the feeding head 50 itself and the three-dimensional object 20 to be printed or said supporting surface 9.

While feeding the continuous filiform element 4, the movement assembly exerts a tractive force on the continuous filiform element 4 and, consequently, transfers it to the continuous fibers contained therein.

It should be noted that this tractive force causes the continuous filiform element 4 to come out from the outlet mouth 10 of the deposition apparatus 1.

Consequently, the greater the relative speed, the faster the continuous filiform element 4 is moved forward.

According to an alternative embodiment, the feeding of the continuous filiform element 4 occurs by extruding it from the feeding head 50.

According to an alternative embodiment, the tension determined on the filiform element as a result of the tractive force applied is modulated as a result of pushing systems positioned upstream of the outlet mouth 10.

In further detail, the movement means comprise at least one machine with numerically controlled movement on at least three axes.

According to a first embodiment, the numerical control machine comprises a motorized arm 23 to support the feeding head 50 mentioned above at a respective end portion.

The motorized arm 23, which is not described in detail since of known type, is adapted to move the feeding head in at least three spatial axes, by orienting the feeding head according to any position with respect to the object 20 or supporting surface 9.

It should be noted that the supporting surface 9, depicted as arranged below the feeding head 50, can in turn be moved relatively with respect to said feeding head 50. Said supporting surface 9 can also be constituted by said continuous filiform element 4 previously deposited in the course of making the three-dimensional object 20.

The equipment further comprises at least one energy source 8 specifically configured to deliver a pre-set amount of energy to the continuous filiform element 4. According to a first embodiment, the aforesaid at least one energy source 8 can be constituted by a heat emission source provided for heating the continuous filiform element 4 and/or determining the activation of chemical species which determine a polymerization reaction.

The energy sources 8 of this type can be based on the supply of a flow of hot air, such as those represented in the figures.

Alternatively, the aforesaid at least one energy source 8 can be a source of electromagnetic radiation used for heating said filiform element and/or determining the activation of chemical species which determine a polymerization reaction. In this case, the energy source 8 can, for example, consist of at least one source of electromagnetic radiation in the infrared and/or ultraviolet field, depending on the type of material which the continuous filiform element 4 is made of. The energy source 8 is positioned downstream of the deposition apparatus 1 and is configured to deliver energy to the continuous filiform element 4.

Preferably, the aforesaid at least one energy source 8 is constituted by an energy source with adjustable power and/or by a movement device configured to change the relative distance between the energy source 8, or one of its elements, and the continuous filiform element 4 being deposited.

If, for example, the energy source 8 is based on generating a flow of hot air adapted for striking the continuous filiform element 4 being deposited, stability of the process can be obtained by modulating the flow of air in terms of flow rate and/or temperature and/or by using a movement device which changes the relative distance between the energy source 8 and the continuous filiform element 4.

If, for example, the energy source 8 is a source of electromagnetic radiation focused by means of an optical element, the change of the geometric configuration of the radiation incident the continuous filiform element 4 can be obtained by means of a movement device which changes the relative distance between the energy source 8 and the continuous filiform element 4 (i.e. moving away from/towards) or by using an operated optical element, i.e. able to change its position.

Another problem inside systems for three-dimensionally printing composite material manufactured articles with continuous fiber reinforcement by using numerically controlled deposition systems or robots provided with 3 or more degrees of freedom concerns the lack of control over the tension exhibited by the filiform element being deposited.

For such purpose, the equipment according to the present invention further comprises a device for controlling the tension exhibited by the continuous filiform element 4 being deposited.

Said device comprises at least one tension sensor for measuring the tension of the continuous filiform element 4 and at least one actuating element configured for compensating undesired tension variations of the continuous filiform element 4.

The aforesaid at least one sensor can be a sensor configured for directly measuring the tension, as in the case of the use of force sensors, or a sensor configured for indirectly measuring the tension, preferably through the synergistic use of an angular and/or linear position sensor and at least one elastic element.

Preferably, the aforesaid at least one sensor is a sensor configured for indirectly measuring the tension.

In these cases, it is conveniently possible to provide the control device with a counterweight having a mass equivalent to the sum of the mass of the system to be counterbalanced. The addition of a counterweight allows the continuous filiform element 4 to have lower tensions since, despite the accelerations of the numerical control machine, the inertia of the system is compensated by the inertia of the counterweight. This ensures that the elastic element, which is part of the sensor for measuring the tension of said continuous filiform element 4, will undergo a variation of its characteristic length solely caused by the tension present on the continuous filiform element 4.

The actuating elements can act by operating the rotation of the bobbin(s) on which the filiform element is wound, thus causing it to unwind, resulting in the feeding of said continuous filiform element 4 and/or imparting a tractive force on the continuous filiform element 4.

The latter effect can be obtained by using, for example, two counter-rotating rollers or by means of a series of rollers, of which at least one is operative, operating as a result of friction with the continuous filiform element 4. Moreover, in the latter case, the last rollers of the series of rollers can be provided with a one-way clutch to ensure tension on the continuous filiform element 4 in the event of its retraction.

The present invention further concerns a method for three-dimensional printing of composite materials, which comprises the steps of:
feeding at least one continuous filiform element 4 to a deposition apparatus 1; said continuous filiform element 4 comprising at least one dispersed phase and at least one continuous phase able to undergo chemical and/or physical changes as a result of a delivery of energy;
setting the aforesaid device to vary the shape of the section of the continuous filiform element;
depositing the continuous filiform element onto a supporting surface or three-dimensional object, by imparting a shape to the section of said continuous filiform element through the combined containment action of the at least one wall of said device and the continuous filiform element previously deposited and/or supporting surface;
delivering a pre-set amount of energy to said filiform element so as to induce a chemical and/or physical change in said filiform element and, as a result of said change, to produce one anchorage point between said filiform element being deposited and said supporting surface and/or three-dimensional object. Said continuous phase constituting said continuous filiform element 4 is selected for being able to quickly make said anchorage point as a result of said chemical and/or physical change, thus determining the possibility to create the three-dimensional object.
displacing said feeding head with respect to the anchorage point according to a pre-set path defining the object to be printed and simultaneously exerting a tractive force onto said continuous filiform element. Said tractive force drives the feeding of said filiform element through the deposition head and is generated as a result of the relative movement between the feeding head and said anchorage point on the supporting surface or three-dimensional object.
during the depositing step, inducing said chemical and/or physical change in a new portion of the filiform element deposited by said feeding head and, as a result of said change, determining, instant by instant, a new anchorage point between said filiform element being deposited and said supporting surface or three-dimensional object.
cutting the continuous filiform element inside the feeding head.

The feeding and depositing steps are carried out by exerting a dragging force on the continuous filiform element 4 made by means of relative movement between the feeding head 50 and the three-dimensional object 20 to be printed or between the feeding head 50 and the supporting surface 9.

In other words, by moving the feeding head 50 by means of the action of the numerical control machine, the continuous filiform element 4 is gradually deposited onto the supporting surface 9 or onto a previously made portion of said three-dimensional object 20 which is produced by feeding the continuous filiform element 4 and by making successive anchorage points.

The deposition of the continuous filiform element 4 can thus proceed according to pre-set paths and trajectories adapted for forming the three-dimensional object 20 to be printed.

The anchorage point thus formed allows the continuous filiform element 4 to be arranged on the supporting surface 9 according to a precise path and to draw, while the numerical control machine is moving, the object to be printed 20.

The feeding head 50 is thus displaced by the numerical control machine according to a pre-set path which defines the object 20 to be printed.

This path is determined by suitable management software which is not described in the present description since it does not fall within the scope of the invention.

At the end of the printing process, or anyhow whenever the continuous feeding of the continuous filiform element 4 must be interrupted, said filiform element is cut by a cutting device 2 advantageously placed inside the feeding head 50.

In order to implement the cutting step, the cutting edge 3 is displaced, in plan view, from a backward position, in which it is away from the extension direction X-X shown in FIGS. 4a-4b of the continuous filiform element 4, to a second cutting position shown in FIGS. 5a-5b, in which the cutting edge 3 intersects the extension direction X-X of the continuous filiform element 4.

In the backward position, the cutting edge 3 and the supporting arm 6 are arranged sideways with respect to the extension direction X-X.

In particular, the supporting arm 6 is arranged so as its extent forms an angle a less than or equal to 45° with the extension direction X-X.

Instead, in the cutting position, as shown in FIGS. 5a-5b, the cutting edge 3 is below the continuous filiform element 4, preferably without touching it and thus intersecting the extension direction X-X.

In order to displace the cutting edge 3, the actuator 16 is operated, which actuator displaces the supporting arm 6 and consequently the cutting edge 3 by bringing it to the cutting position shown in FIGS. 5a, 5b.

In the backward position of the conveyor 5, FIGS. 4a, 4b, the latter is arranged aligned with the extension direction X-X of the continuous filiform element 4, above and without being in interference with the continuous filiform element 4.

In other words, when considering a vertical direction such as the one represented by the vertical axis Z-Z, the continuous filiform element 4 is above the cutting edge 3 but below the conveyor 5.

At this point, the conveyor 5, operated by a specific actuating system 18, also moves from a backward position thereof, in which it is away from the cutting edge 3 (shown in FIGS. 5a, 5b), to an intermediate position shown in FIGS. 6a, 6b, in which it is below the cutting edge 3 whenever the latter is in its cutting position.

In the intermediate position of the conveyor 5, FIGS. 6a, 6b, the latter is arranged aligned with the extension direction X-X of the continuous filiform element 4.

In this position of the conveyor 5, the continuous filiform element 4, in particular its length arranged in proximity of the engagement portion 12, winds the cutting edge 3 and the head portion 11 of the conveyor 5 thus forming an “s”.

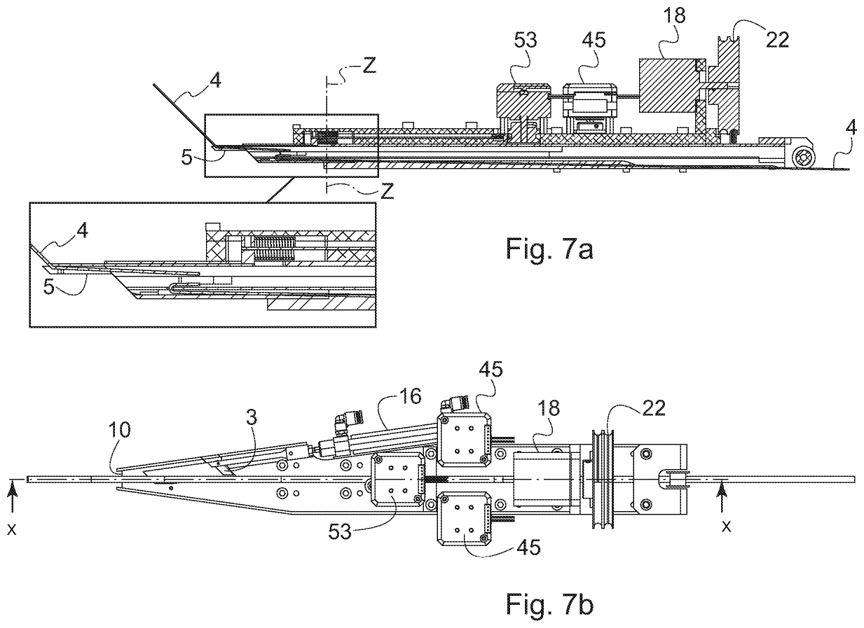

At this point, the cutting edge 3 is once again brought to the backward position, the cutting edge 3 comes into contact with the continuous filiform element 4 during this movement, thus determining its cutting, FIGS. 7a, 7b.

Successively, the conveyor 5 is further displaced forward, i.e. further away from the backward position to a forward position shown in FIGS. 8a, 8b. In this position, the continuous filiform element 4 is now cut, while the leading end 11 of the conveyor comprising the engagement portion 12 comes out of the front from the outlet mouth 10 of the deposition apparatus 1, thus engaging the resulting flap of the filiform element for its new positioning so as to form a new anchorage point for the successive depositing step.

In the forward position, the conveyor 5 is substantially below the cutting edge 3, which is in its backward position. The continuous filiform element 4 is below the conveyor 5, except for its free end portion.

At the exit of the outlet mouth 10, before or after cutting, the energy source 8 delivers a pre-set amount of energy to said continuous filiform element 4 so as to induce a chemical and/or physical change in said filiform element and, as a result of said change, to produce one anchorage point between said filiform element being deposited and said supporting surface 9 and/or three-dimensional object 20. The transformation of the continuous filiform element 4 into a composite material is triggered in proximity and downstream of the outlet mouth 10, thus consequently determining an anchorage point between the continuous filiform element 4 being deposited and the supporting surface 9 and/or three-dimensional object 20.

Before or while depositing the continuous filiform element 4 according to the pre-set trajectory, the continuous filiform element 4 can undergo a shaping step to vary the form of the section.

To this end, the shaping device 40 is set by moving the aforesaid movable walls 41, 42, 43 towards or away from each other.

With reference to the embodiment shown in the figures, the side walls 41, 42 and/or the upper wall 43 can be moved at least partially towards/away from each other in order to compress the continuous filiform element 4 both sideways and vertically.

As previously mentioned, the setting step can be implemented during the depositing step.

Alternatively or in combination, the setting step can be implemented upstream of the depositing step.

Advantageously, the method described can be applied to the making of geometries which are characterized by curvatures in the stratification direction of the three-dimensional object by setting said shaping device 40 dynamically during the depositing step of said continuous filiform element 4.

Advantageously, the method described can be applied to the deposition of continuous filiform element(s) having trajectory/s and deposition at least partially intersecting on the same plane or surface by setting said shaping device 40 dynamically during the depositing step of said continuous filiform element 4.

As can be clearly deduced from the description above, the invention allows to overcome the limitations of the known equipment and processes for three-dimensional printing of fiber composite materials, in particular in terms of the limits of the methods for shaping the continuous filiform element.

Several changes can be made to the embodiments described in detail, all anyhow remaining within the protection scope of the invention, as defined by the following claims.

1. Equipment (100) for three-dimensional printing of continuous fiber composite materials, comprising:
a feeding head (50) for feeding at least one continuous filiform element (4); said continuous filiform element (4) comprising at least one dispersed phase and at least one continuous phase; said feeding head (50) comprising at least one deposition apparatus (1) arranged in its end portion;
a movement assembly for the relative movement between the feeding head (50) and the three-dimensional object to be printed (20) or supporting surface (9);
at least one energy source (8) configured to deliver a pre-set amount of energy to said continuous filiform element (4);
characterized in that said deposition apparatus (1) comprises:
a device (40) for varying the shape of the section of the continuous filiform element (4) being deposited, comprising at least one side surface configured to be in contact with the continuous filiform element (4), thus occupying at least one portion of the outer perimeter of the section of said continuous filiform element (4) and so as to define an empty portion on the outer perimeter of the section of said continuous filiform element (4) equal to or greater than 5% of the outer perimeter of the section of said continuous filiform element (4).

2. Equipment (100) for three-dimensional printing of continuous fiber composite materials according to claim 1, wherein the device (40) comprises at least two movable walls (41,42,43) configured to be in contact with the continuous filiform element (4) being deposited, thus occupying at least one portion of the section of its outer perimeter;
said movable walls (41,42,43) being movable away from or towards the center of the section of the filiform element (4).

3. Equipment (100) for three-dimensional printing of continuous fiber composite materials according to claim 2, characterized in that said at least two walls (41,42,43) occupy at least 30% of the outer perimeter of the section of said continuous filiform element (4).

4. Equipment (100) for three-dimensional printing of continuous fiber composite materials according to claim 2 ss-3, characterized in that said at least two movable walls (41,42,43) comprise two side walls (41,42) opposite with respect to said continuous filiform element; each side wall (41,42) comprising a free end (41a,42a) and an end (41b,42b) constrained to a head (44).

5. Equipment (100) for three-dimensional printing of continuous fiber composite materials according to claim 4, characterized by comprising a movement assembly for moving said two movable walls (41,42) and which comprises at least one actuator (45) configured to determine the translation of the side walls (41,42).

6. Equipment (100) for three-dimensional printing of continuous fiber composite materials according to claim 3, characterized by having an upper wall (43) arranged inside the feeding head (50) so as to be positioned orthogonally to said side walls (41,42).

7. Equipment (100) for three-dimensional printing of continuous fiber composite materials according to claim 6, characterized in that said deposition apparatus (1) comprises a device adapted for measuring the pressure exerted by the upper wall (43) onto the continuous filiform element (4).

8. Apparatus (100) for three-dimensional printing of continuous fiber composite materials according to claim 6, characterized by comprising a movement assembly for moving the upper wall (43) which comprises at least one actuator (53) which determines the translation of the upper wall (43) with respect to the extension direction of the continuous filiform element (4).

9. Process for three-dimensional printing continuous fiber composite materials with the equipment (100) according to claim 1, comprising the steps of:
feeding at least one continuous filiform element (4) to a deposition apparatus (1);
depositing the continuous filiform element onto a supporting surface and/or three-dimensional object while imparting a shape to the section of said continuous filiform element (4) through the combined containment action of at least one wall of said device and of said continuous filiform element (4) previously deposited and/or of said supporting surface;
delivering a pre-set amount of energy to said continuous filiform element (4) so as to induce a chemical and/or physical change in said filiform element and, as a result of said change, to produce at least one anchorage point between said continuous filiform element being deposited and said supporting surface and/or three-dimensional object;
displacing said feeding head (50) with respect to the anchorage point according to a pre-set path defining the object to be printed (20);
setting said device (40) to vary the shape of the section of the continuous filiform element (4);
cutting the continuous filiform element (4).

10. Process for three-dimensional printing continuous fiber composite materials according to claim 9, characterized in that said setting step is implemented upstream of said depositing step.

11. Process for three-dimensional printing continuous fiber composite materials according to claim 9, characterized in that said setting step is implemented during the depositing step.
